(19) United States
(12) Patent Application Publication
(10) Pub. No.: US 2026/0239187 A1
(43) Pub. Date: Aug. 13, 2026

(54) CELLULAR CARRIER SELECTION BASED ON PERFORMANCE PARAMETERS

(71) Applicant: ITRON, INC., Liberty Lake, WA (US)

(72) Inventors: Christopher Lloyd OSTERLOH, Waseca, MI (US); Matthew ROCKEY, Fishers, IN (US)

(21) Appl. No.: 19/050,727

(22) Filed: Feb. 11, 2025

(51) Int. Cl. H04W 48/20; H04W 48/16; H04W 72/0453

(52) U.S. Cl. CPC H04W 48/20; H04W 48/16; H04W 72/0453

(57) ABSTRACT

Various embodiments disclose a connectivity management service that identifies an estimated capacity for a first network sector corresponding to a first carrier network, measures average latency for the network sector based on endpoint devices that communicate using the network sector, determines an actual available capacity for the network sector based on the average latency and the estimated capacity, and transmits instructions for an endpoint device of the endpoint devices to change from the first network sector to a second network sector.

### BACKGROUND

### Field of the Various Embodiments

The various embodiments relate generally to communications networks, and more specifically, to cellular carrier selections based on performance parameters.

### Description of the Related Art

Many enterprises can manage a large number of remote devices. For example, enterprises that control and/or monitor large infrastructure systems (e.g., power, water, traffic control, and the like) can include many thousands of devices (e.g., valves, metering devices, controllers, and the like). Generally, each device reports metrology data to and/or receives commands from one or more endpoint infrastructure management systems, which are tasked with coordinating the operation of the devices. Devices are often deployed in the field so that they communicate with endpoint infrastructure management systems over different networks that are operated by different network providers. These different networks can provide connectivity using different towers, different transport protocols, security requirements, and/or the like. As a result, connectivity, outages, speed, latency, and other network parameters can differ from network to network.

### BRIEF DESCRIPTION OF THE DRAWINGS

So that the manner in which the features of the various embodiments can be understood in detail, a description of the inventive concepts may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a conceptual diagram of a network environment for a connectivity management service, according to various embodiments.

FIG. 2 illustrates a more detailed view of the computing system 102, according to various embodiments.

FIG. 3 illustrates a more detailed view of an endpoint device of FIG. 1, according to various embodiments.

FIG. 4 illustrates an example of operations performed by the connectivity management service of FIG. 1, according to various embodiments.

FIG. 5 illustrates a flow diagram of method steps for the connectivity management service to evaluate whether to perform load balancing, according to various embodiments.

FIG. 6 illustrates a flow diagram of method steps for the connectivity management service to perform one or more load balancing operations, according to various embodiments.

FIG. 7 illustrates a flow diagram of method steps for an endpoint device to facilitate one or more load balancing operations, according to various embodiments.

### DETAILED DESCRIPTION

In the following description, numerous specific details are set forth to provide a more thorough understanding of the various embodiments. However, it will be apparent to one of skill in the art that the inventive concepts may be practiced without one or more of these specific details.

Many enterprises deploy large numbers of endpoint devices, such as power meters, water meters, streetlight controllers, traffic controllers, and the like, to back-office management systems that monitor and/or control the endpoint devices. To deploy meters and other endpoint devices over a large geographic area, various carrier networks operated by different network providers under different access conditions are utilized. In many cases the endpoint devices include a single subscriber identity module (SIM) having multiple carrier profiles that enable communications using multiple different carrier networks.

Carrier networks can provide coverage that is separated into a number of sectors. Each sector provides connectivity to enterprise managed endpoint devices as well as other devices from other users. A sector can become overloaded based on enterprise usage, but also as a result of other activity (e.g., other enterprises and users) in the sector, network errors, among other factors. Different carrier networks can provide connectivity using different towers, different transport protocols, security requirements, and the like. As a result, connectivity, outages, speed, latency, and other carrier network parameters can differ from network to network and sector to sector within the same network. While the enterprise can use the same set of carrier networks for all endpoint devices, different multi-carrier SIM (and endpoint devices) can alternatively enable connectivity using a SIM-specific set of carrier networks. As the deployment integrates additional endpoint devices, additional carrier networks are often utilized. Accordingly, a given enterprise is tasked with managing connectivity for a large network of endpoint devices deployed across a heterogeneous network served by multiple different carrier networks.

Enterprises often desire to use a particular carrier based on connectivity, costs, and other considerations such as reliability, congestion, and the like. The present disclosure describes mechanisms that manage carrier profiles for endpoint devices using a connectivity management service that determines actual available capacity for cellular sectors of multiple carriers. The connectivity management service identifies an estimated or calculated capacity (e.g., an estimate of total allocated capacity and/or other total capacity) of each sector. The connectivity management service periodically commands endpoint devices to provide data, and observe latencies of the endpoint devices (e.g., time to provide the data). Alternatively, the endpoint devices are configured to periodically provide the data. The connectivity management service also receives indications of connection failures from the endpoint devices. The connectivity management service combines this information to identify an actual available capacity of the sector, because increased latency and connection failures are correlated with lower actual available capacity. The connectivity management service uses the information to identify the alternate (e.g., non-enterprise) load on the sector. In some examples, the actual available capacity corresponds to a difference between an estimated total capacity of a sector and the alternate or non-enterprise load on the sector.

The connectivity management service maximizes available capacity metrics across all sectors by directing individual endpoints that are connected using a lower-available-capacity sector of one carrier network to change carrier profile to connect using a higher-available-capacity sector of the same or another carrier network in the same area as the endpoint device. The connectivity management service also maintains a history or log of endpoint-specific connectivity data (e.g., signal strengths, disconnection rates, and other information for each carrier). The connectivity management service identifies which endpoints to reassign using the endpoint-specific connectivity data. Endpoint devices having lower signal strengths and/or higher disconnection rates use an additional energy as the devices attempt communication multiple times and struggle to complete data transfers. These devices also use more capacity than devices with better connectivity.

At least one technical advantage of the disclosed techniques is that the disclosed techniques increase overall actual capacity across all sectors utilized by an enterprise. The disclosed techniques reduce disconnection rates and power usage while available capacity is balanced across all sectors. Additionally, the disclosed techniques further increase overall actual capacity across all sectors and increase battery lifetime for battery-powered endpoint devices.

### Networked Environment

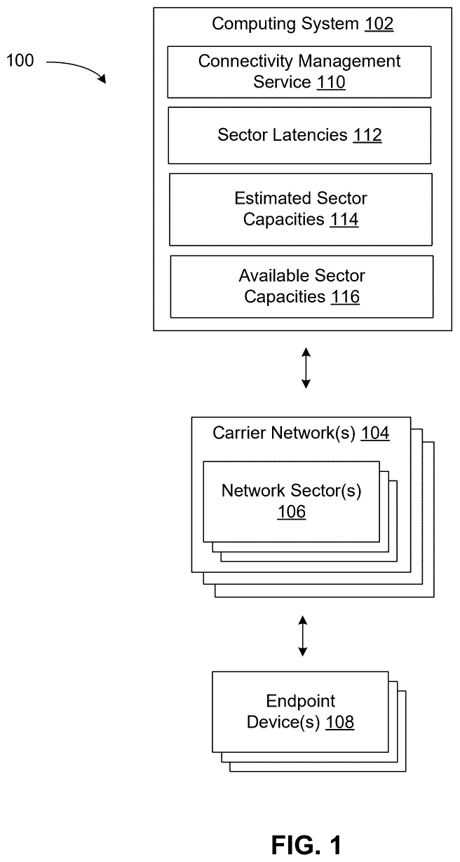

FIG. 1 is a conceptual diagram of the operation of a networked environment 100 that includes, without limitation, a computing system 102, carrier networks 104, network sectors 106, and one or more endpoint devices 108. The computing system 102 includes, without limitation, a connectivity management service 110, sector latencies 112, estimated sector capacities 114, and available sector capacities 116.

Computing system 102 represents one or more computing devices, services, or systems through which the connectivity management service 110 communicates with carrier networks 104 and endpoint devices 108. The computing system 102 uses one or more processors to execute the connectivity management service 110. The computing system 102 uses one or more storages devices to store instructions including the connectivity management service 110 as well as sector latencies 112, estimated sector capacities 114, and available sector capacities 116.

Each of the carrier networks 104 provides a cellular or other type of wide area network that includes one or more network sectors 106. The carrier network 104 includes, without limitation, one or more base stations, one or more network devices such as routers, switches, and gateways, one or more radio communications devices, and so on. A carrier network provides one or more base stations corresponding to one or more cells. Each cell includes one or more network sectors 106, such as 1, 2, 3, 4, 5, 6, or more network sectors 106. As a result, a carrier network 104 provides network coverage using the network sectors 106.

The connectivity management service 110 manages connectivity of the various endpoint devices 108 by communicating with the endpoint devices 108 and/or the carrier networks 104. The connectivity management service 110 manages one or more endpoint devices 108, each of which can include a multi-carrier SIM. The multi-carrier SIM enables an endpoint device 108 to connect to multiple different carrier networks 104. The connectivity management service 110 registers one or more endpoint devices 108, including communication information for direct communications with the endpoint device 108. The connectivity management service 110 can store data that includes a location, region, endpoint deployment group, or other data of the particular endpoint device 108. In some examples, the endpoint device 108 is a stationary device statically located in a particular geographic location.

The sector latencies 112 can refer to one or more sector-specific latency metrics (e.g., average, mean, upper quartile, lower quartile etc.) for respective ones of the network sectors 106. The connectivity management service 110 calculates a sector latency 112 using data received and/or retrieved from the endpoint devices 108 that connect using that network sector 106. To this end, the connectivity management service 110 periodically instructs the endpoint devices 108 to transmit a report or other data. Because the connectivity management service 110 instructs the endpoint devices 108 at the same time (e.g., concurrently, with partial concurrence, or sequentially), the reporting period for responses from the endpoint devices 108 acts as a stress test on the network sector 106. If the network sector 106 is heavily loaded, an aggregate metric corresponding to the sector latency 112 will be higher relative to a lightly loaded network sector 106. In examples where the sector latencies 112 are determined based on the reporting period, the sector latencies 112 can be referred to as sector-specific reporting latencies. Higher sector latency 112 metrics relate to lower available sector capacity 116. However, if the network sector 106 is lightly loaded, an aggregate metric corresponding to the sector latency 112 will be lower relative to a lightly loaded network sector 106. Lower sector latency 112 metrics relates to higher available capacity 116. Accordingly, the connectivity management service 110 identifies a relationship or set of rules that inversely relates sector latency 112 with available sector capacity 116.

In one example, the connectivity management service 110 determines actual available sector capacity 116 based on the sector latency 112 and an estimated sector capacity 114. The available sector capacity 116 corresponds to a difference between an estimated (e.g., total) sector capacity 114 and a capacity used by non-enterprise devices (e.g., alternate load). However, the enterprise does not have access to the non-enterprise devices. The connectivity management service 110 uses the sector latency 112 to determine the available sector capacity 116 without using the alternate load. Additionally or alternatively, the connectivity management service 110 uses the sector latency 112 to estimate alternate load, and determines the available sector capacity 116 based on a difference between the estimated sector capacity 114 and the estimated alternate load. The connectivity management service 110 can also use disconnection rates, signal strengths, and/or the like to identify the available sector capacity 116 and/or the alternate load. The estimated sector capacity 114 is a sector-specific upper limit (and/or available) capacity based on one or more protocols used by the network sector 106 and an allocated capacity such as a service level capacity according to a contract with the corresponding carrier network 104. The connectivity management service 110 identifies an estimated sector capacity 114 for a first network sector 106, where the first network sector 106 corresponds to a first carrier network 104. The connectivity management service 110 measures a sector latency 112 metric for the first network sector 106 based on individual latencies of endpoint devices 108 in the network sector 106. An individual latency of an endpoint device 108 refers to a time from a starting time such as a time the connectivity management service 110 transmitted instructions to provide a report (or a configured or agreed upon time to provide the report), to a time that the report is received from the endpoint device 108. In this context, measuring the sector latency 112 metric includes measuring and aggregating individual latencies for the endpoint devices 108 to generate the sector latency 112 metric.

Continuing the example, the connectivity management service 110 determines an actual available sector capacity 116 for the first network sector 106 based on the sector latency 112 and the estimated sector capacity 114. The connectivity management service 110 identifies actual available sector capacities 116 for a set of multiple network sectors 106 such as network sectors 106 in a particular area, and/or another set of network sectors 106 used by an enterprise. The connectivity management service 110 performs load balancing by reassigning one or more endpoint devices 108. For example, the connectivity management service 110 transmits instructions for an endpoint device 108 to change from the first network sector 106 to a second network sector 106. In some embodiments, the second network sector 106 is a network sector 106 provided using a different carrier network 104 than the first network sector 106. However, in other embodiments, the second network sector 106 is provided using the same carrier network 104 as the first network sector 106.

### Computing Device

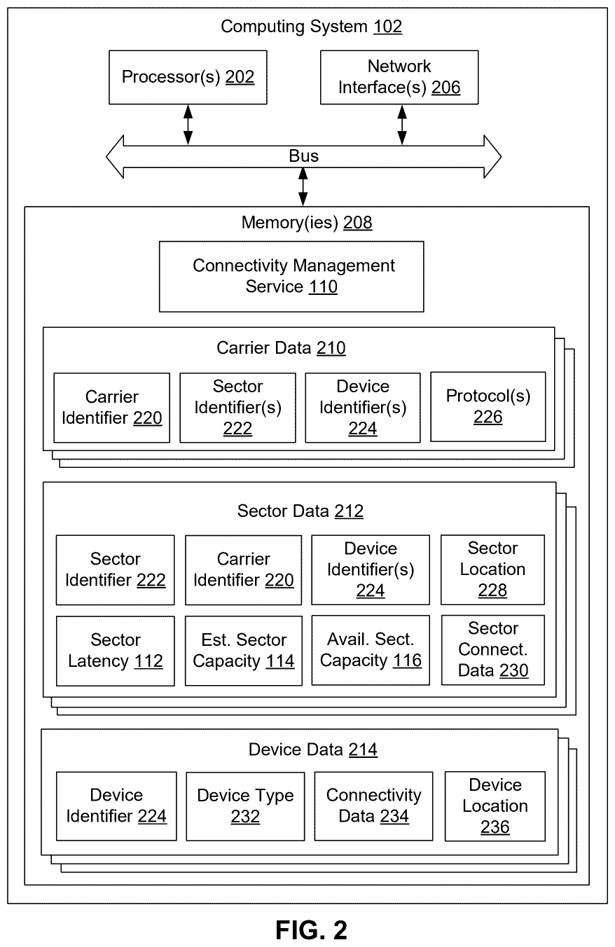

FIG. 2 illustrates a more detailed view of the computing system 102, according to various embodiments. In some embodiments, the computing system 102 includes a computing device, such as a backend server, or some other computing device, located at an office or other facility of a utility provider. In some embodiments, the computing system 102 is implemented as a cluster of computing devices. As shown, the computing system 102 includes, without limitation, one or more processors 202, one or more network interfaces 206, and one or more memories 208, coupled together. The one or more memories 208 include, without limitation, carrier data 210, sector data 212, and device data 214. Carrier data 210 (e.g., for each carrier network 104) includes, without limitation, a carrier identifier 220, one or more sector identifiers 222, one or more device identifiers 224, and protocols 226. Sector data 212 (e.g., for each network sector 106) includes, without limitation, a sector identifier 222, a carrier identifier 220, one or more device identifiers 224, a sector location 228, a sector latency 112, an estimated sector capacity 114, an available sector capacity 116, and sector connectivity data 230. The device data 214 (e.g., for each endpoint device 108) includes, without limitation, a device identifier 224, a device type 232, connectivity data 234, and a device location 236.

The one or more processors 202 coordinate operations of the computing system 102. In various embodiments, processor 202 includes any hardware configured to process data and execute software applications. The processor 202 can be any technically feasible processing device configured to process data and execute program instructions. For example, processor 202 could include one or more central processing units (CPUs), digital signal processors (DSPs), graphics processing units (GPUs), application-specific integrated circuits (ASICs), field-programmable gate arrays (FPGAs), microprocessors, microcontrollers, other types of processing units, and/or a combination of different processing units.

The one or more network interfaces 206 include devices configured to receive input, devices configured to provide output, and devices configured to both receive input and provide output. The one or more network interfaces 206 are configured to receive data and/or transmit data to and from devices providing the carrier networks 104 and/or other service providers.

Memory 208 can include any technically feasible storage device, such as a random-access memory (RAM) module, a flash memory unit, a hard disk drive, non-volatile storage, or any other type of memory unit or combination thereof. Memory 208 is shown storing executable components of a connectivity management service 110 as well as data including carrier data 210, sector data 212, and device data 214.

The connectivity management service 110 manages connectivity of the various endpoint devices 108. As indicated above, the connectivity management service 110 determines actual available sector capacities 116 for a set of network sectors 106, and reassigns endpoint device 108 to balance the available sector capacities 116 across the network sectors 106. To this end, the connectivity management service 110 stores and accesses carrier data 210, sector data 212, and device data 214.

The carrier data 210 includes information about carrier networks 104 within a networked environment 100 (see FIG. 1). The carrier data 210 is shown as a plurality of carrier-specific data records. In the example shown, each carrier-specific data record includes, without limitation, a carrier identifier 220 of the relevant carrier network 104, sector identifiers 222, device identifiers 224, and protocols 226. The carrier identifier 220 includes identifying information for the carrier network 104 of the data record. The carrier identifier 220 includes universally unique identifier (UUID) or another value that identifies the carrier network 104 among other carrier networks 104. The sector identifiers 222 include identifying information (e.g., UUID or another value) for respective ones of the network sectors 106 of the carrier network 104. The device identifiers 224 include a device identifying information for respective ones of a set of endpoint devices 108 connected to the various network sectors 106 of the carrier network 104. The device identifiers 224 include a unique device identifier (UDID), a UUID, an International Mobile Subscriber Identity (IMSI) of a SIM of the endpoint device 108, or another value. The protocols 226 include one or more protocols used for communications using the carrier network 104 and/or individual network sectors 106. The protocols 226 include fifth-generation new radio (5GNR), various fourth generation categories (4G Cat-X), 4G Cat M1, Narrowband Internet of Things (NB IoT), and/or the like. While shown as being stored in the carrier data 210, the protocols 226 can also include sector-specific sector protocols for individual network sectors 106. The sector-specific sector protocols can be stored in the carrier data 210 as well as in the sector data 212 for the corresponding network sector 106.

The sector data 212 includes information about individual sectors 106 within a networked environment 100 (see FIG. 1). The sector data 212 is shown as a plurality of sector-specific data records. In the example shown, each sector-specific data record includes a sector identifier 222 of the relevant network sector 106, a carrier identifier 220, device identifiers 224, a sector location 228, a sector latency 112, an estimated sector capacity 114, an available sector capacity 116, and sector connectivity data 230. The sector identifier 222 includes identifying information for the network sector 106 of the data record. The carrier identifier 220 includes identifying information for the carrier network 104 that provides the network sector 106. The device identifiers 224 include device identifying information for respective ones of a set of endpoint devices 108 connected to the network sector 106.

The sector location 228 indicates a geographic area or location where the network sector 106 provides network connectivity. The sector location 228 is indicated using one or more perimeter lines, a diameter from a particular location, and/or the like. A sector latency 112 refers to one or more sector-specific latency metrics for the network sector 106. The estimated sector capacity 114 is a sector-specific upper limit (and/or available) capacity value that is generated based on one or more protocols used by the network sector 106 and an allocated capacity such as a service level capacity according to a contract. The available sector capacity 116 is an actual available capacity of the network sector 106. The connectivity management service 110 determines actual available sector capacity 116 based on one or more of the sector latency 112, the estimated sector capacity 114, the expected bandwidth values (e.g., based on device types 232) for the endpoint devices 108 in the network sector 106, or the sector connectivity data 230. The sector connectivity data 230 indicates aggregated metrics of disconnection rates, signal strengths, and other connectivity data 234 of endpoint devices 108 in connection with the network sector 106.

Device data 214 includes information about endpoint devices 108 that are deployed within a networked environment 100 (see FIG. 1). The device data 214 is shown as a plurality of device-specific data records. In the example shown, each device-specific data record includes a device identifier 224, a device type 232, connectivity data 234, and a device location 236. The device identifier 224 includes device-specific information such as a UDID, a UUID, an IMSI of a SIM of the endpoint device 108, or another value. The device type 232 indicates a classification such as valve, metering device, controller, and/or the like. A device type 232 is associated with one or more expected bandwidth or capacity usage values. In some embodiments, the expected capacity usage values include a steady state usage value and a dynamic usage value. The dynamic usage value is generally higher than the steady state usage value. The steady state usage value is associated with an average or mean capacity usage metric or load. The dynamic usage value is associated with a peak, burst, or other increased capacity usage metric or load.

The connectivity data 234 indicates a history of signal strengths, disconnections, and other connectivity information that is identified and stored by an endpoint device 108 periodically. The connectivity management service 110 receives device-specific connectivity data 234 from each endpoint device 108, for example, in reports transmitted by or retrieved from the endpoint devices 108. In some examples, the report includes a device-specific peak, burst, or other increased capacity usage metric, as well as an average or mean capacity usage metric for an endpoint device 108. The connectivity management service 110 determines a device-type-specific steady state usage value based on an average or mean of the device-specific steady state usage metric. The connectivity management service 110 determines a device-type-specific dynamic usage value based on an average or mean of the device-specific dynamic usage metrics.

In some examples, connectivity data 234 includes device-specific latency data from the reports. The latency data includes a radio resource control latency, a dynamic latency, a time-to-register latency, an average time of connection loss, and other information. The radio resource control latency indicates a time delay associated with transitioning an endpoint device 108 from an idle state to a connected state using a radio resource control protocol. The dynamic latency indicates a latency for coordinated simultaneous communication such as a round-trip or ping time between the endpoint device 108 and a tower or other carrier network device. A time-to-register latency indicates an amount of time it takes to register after a failure to register connection with the carrier network 104 (e.g., loss of connectivity). The connectivity data 234 also specifies a number of losses of connectivity, a number of repetitions used for a mandatory operation such as an alarm push operation, a packet reliability value, a negotiated data rate between the endpoint device 108 and the tower or other carrier network device, and/or the like. The sector connectivity data 230 includes aggregated metrics such as an average or mean of the various latencies for endpoint devices 108 of a network sector 106.

In some examples, connectivity data 234 includes device-specific signal strength data. The signal strength data includes one or more signal strength values that indicate signal strength based on metrics such as reference signal received power, signal to interference plus noise, received signal strength indicator, reference signal received quality, and/or the like. The sector connectivity data 230 includes aggregated metrics such as an average or mean of the various signal strengths for endpoint devices 108 of a network sector 106.

The connectivity data 234 also includes connectivity information for a current network sector 106 (and current carrier network 104), as well as information for other network sectors 106 to which the endpoint device 108 has connected in the past. The device location 236 indicates a particular geographic location or area in which the device is located. The device location 236 can refer to a static location and/or a dynamically updated location in the example of a mobile endpoint device 108.

When executed by processor 202, the connectivity management service 110 manages connectivity of one or more endpoint devices 108 and balances available sector capacities 116. The connectivity management service 110 stores and accesses carrier data 210, sector data 212, and device data 214 to perform various functionalities. For example, in order to evaluate a sector latency 112, the connectivity management service 110 identifies a sector identifier 222 for the network sector 106. The connectivity management service 110 retrieves, based on the sector identifier 222, information from the various data records stored in the memories 208 such as device identifiers 224, communication information for instructing the endpoint devices 108 to report data, and other data used for calculating the sector latency 112. In order to generate an estimated sector capacity 114, the connectivity management service 110 retrieves, based on the sector identifier 222, information from the various data records stored in the memories 208 such as protocols 226, service level agreements, allocated capacities, algorithms, relationships, and other data used for calculating the estimated sector capacity 114. In order to generate an available sector capacity 116, the connectivity management service 110 retrieves, based on the sector identifier 222, information from the various data records stored in the memories 208 such as the sector latency 112, algorithms, relationships, and other data used for calculating the available sector capacity 116. The connectivity management service 110 retrieves various information from the data records in order to perform the functionalities described herein.

The connectivity management service 110 determines the actual available sector capacities 116 based on sector latencies 112 and estimated sector capacities 114 for each network sector 106. For each network sector 106, the connectivity management service 110 identifies an estimated sector capacity 114. The connectivity management service 110 measures a sector latency 112 for the network sector 106 based on endpoint devices 108 in the network sector 106. The connectivity management service 110 determines an actual available sector capacity 116 for the first network sector 106 based on the sector latency 112 and the estimated sector capacity 114.

The connectivity management service 110 performs load balancing by reassigning one or more endpoint devices 108. For example, the connectivity management service 110 transmits instructions for the one or more endpoint devices 108 to change from a first network sector 106 to a second network sector 106. In some embodiments, the second network sector corresponds to a second network carrier.

In some embodiments, the connectivity management service 110 performs load balancing based on an analysis of available sector capacities 116 and expected capacity usage values for the endpoint devices 108. The connectivity management service 110 uses the available sector capacity 116 and the expected capacity usage values for the endpoint devices 108 in the network sector 106 to determine an offered (e.g., enterprise-originated total) steady state load and an offered dynamic load for the network sector 106. The connectivity management service 110 identifies the steady state capacity usage values and dynamic capacity usage values for each endpoint device 108 based on a device type 232 of the endpoint device 108. The offered steady state load is a sum of the steady state usage values for the endpoint devices 108 in the network sector 106, for example, according to equation 1.

$$O S S L = C 1 * SSU 1 + C 2 * SSU 2 + C 3 * SSU 3 \qquad ( 1 )$$

In equation 1, OSSL is the offered steady state load for a network sector 106, C1 is a number or count of endpoint devices 108 of a first device type 232 in the network sector 106, SSU1 is a steady state load value for the first device type 232, C2 is a number of endpoint devices 108 of a second device type 232 in the network sector 106, SSU2 is a steady state load value for the second device type 232, C3 is a number of endpoint devices 108 of a third device type 232 in the network sector 106, and SSU3 is a steady state load value for the third device type 232. While three device types are represented in equation 1, the equation can be modified to include any number of device types 232 that are present in the network sector 106.

The offered dynamic load is a sum of the steady state usage values for the endpoint devices 108 in the network sector 106, for example, according to equation 2.

$$O D L = C 1 * DU 1 + C 2 * DU 2 + C 3 * DU 3 \qquad ( 2 )$$

In equation 2, ODL is the offered dynamic load for a network sector 106, C1 is a number or count of endpoint devices 108 of a first device type 232 in the network sector 106, DU1 is a steady state load value for the first device type 232, C2 is a number of endpoint devices 108 of a second device type 232 in the network sector 106, DU2 is a dynamic load value for the second device type 232, C3 is a number of endpoint devices 108 of a third device type 232 in the network sector 106, and DU3 is a dynamic load value for the third device type 232. While three device types are represented in equation 2, the equation can be modified to include any number of device types 232 that are present in the network sector 106.

In some embodiments, the connectivity management service 110 balances the network sectors 106 according to equations (3) and (4).

$$O S S L < X \qquad ( 3 )$$

$$O D L < Y \qquad ( 4 )$$

In equation 3, X represents a first threshold percentage of the actual available sector capacity 116. In equation 4, Y represents a second threshold percentage of the actual available sector capacity 116. The connectivity management service 110 identifies whether the offered steady state load of the network sector 106 is less than the first threshold percentage X, according to equation 3. The connectivity management service 110 identifies whether the offered dynamic load of the network sector 106 is less than the second threshold percentage Y, according to equation 4. In some embodiments, the second threshold percentage Y is higher than the first threshold percentage X. If the offered steady state load of the network sector 106 is greater than (or equal to) the first threshold percentage X and/or the offered dynamic load of the network sector 106 is greater than (or equal to) the second threshold percentage Y, then the connectivity management service 110 performs load balancing actions.

In some embodiments, the connectivity management service 110 also identifies one or more reserve capacities for a network sector 106. The one or more reserve capacities for a network sector 106 includes a steady state reserve capacity and a dynamic reserve capacity. The steady state reserve capacity is a capacity amount or percentage the network sector 106 is under the first threshold (or available sector capacity 116). The dynamic reserve capacity is a capacity amount or percentage the network sector 106 is under the second threshold (or available sector capacity 116). However, if all network sectors 106 in the area are greater than or equal to one or more of the threshold capacity percentages, the connectivity management service 110 still balances the system by reassigning one or more endpoint devices 108 to the lowest over-capacity network sector 106 to maximize performance.

The connectivity management service 110 reassigns one or more endpoint devices 108 to a second network sector 106 such that the offered steady state load and the offered dynamic load of the second network sector 106 remains less than (or equal to) the first threshold percentage and the second threshold percentage. In some embodiments, the connectivity management service 110 determines that a sum of the steady state capacity usage values for the one or more endpoint devices 108 is less than the steady state reserve capacity of the second network sector 106, and that a sum of the dynamic capacity usage values for the one or more endpoint devices 108 is less than the dynamic reserve capacity of the second network sector 106. Additionally or alternatively, the connectivity management service 110 determines the offered steady state load and the offered dynamic load of the second network sector 106 based on the expected capacity usage values for the endpoint devices 108 in the second network sector 106 and the expected capacity usage values for the one or more endpoint devices 108 selected to change from the first network sector 106 to the second network sector 106.

The connectivity management service 110 performs a number of additional functionalities using the carrier data 210, the sector data 212, and/or the device data 214. For example, the connectivity management service 110 calculates the estimated sector capacity 114 based on one or more protocol 226 used by the network sector 106, and/or an allocated bandwidth of the network sector 106. To this end, the connectivity management service 110 retrieves the protocol 226 and the allocated bandwidth from the carrier data 210 and/or the sector data 212.

In some embodiments, the connectivity management service 110 determines and compares available sector capacities 116 for a set of network sectors 106 in order to identify the first network sector 106 for load balancing actions, such as changing the sector of the endpoint device 108. For example, the connectivity management service 110 load balances available capacities 116 by identifying available sector capacities 116 for the first and second network sectors 116, and determining that the second (e.g. destination) network sector 106 is associated with a higher available sector capacity 116 relative to the first network sector 106. As a result, the available sector capacities 116 are more balanced once the endpoint device 108 changes from the first network sector 106 to the second network sector 106. The connectivity management service 110 is capable of predicting a post-sector change available sector capacity 116 for the first network sector 106 and/or the second network sector 106. The connectivity management service 110 compares post-sector change available sector capacities 116 with current available sector capacities 116 to ensure the sector change improves a balance of the available sector capacities 116.

The connectivity management service 110 also selects the endpoint device 108 to change from the first network sector 106 to the second network sector 106 based on the connectivity data 234 (and/or the sector connectivity data 230) indicating a lower signal strength and/or a higher disconnection rate relative to other endpoint devices 108 in the first network sector 106. This can improve battery life for the endpoint device 108 as well as reduce bandwidth usage in one or more network sectors 106. To further optimize the selection of the endpoint device 108, the connectivity management service 110 uses historical connectivity data 234 indicating that the endpoint device 108 is associated with a higher signal strength for the second network sector 106 relative to the first network sector 106.

### Endpoint Device(s)

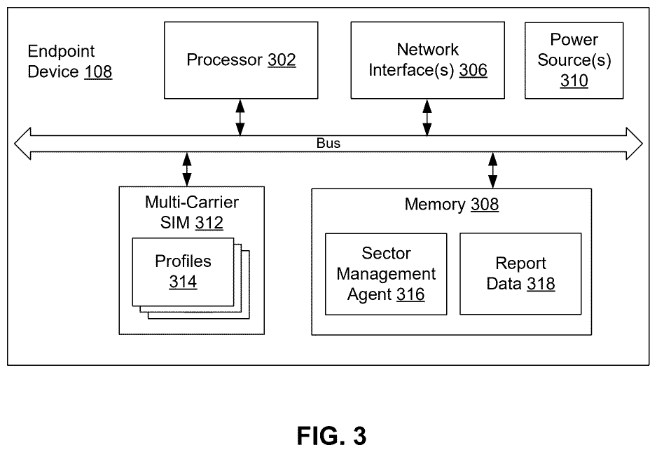

FIG. 3 illustrates a more detailed view of an endpoint device 108, according to various embodiments. In some embodiments, the endpoint device 108 includes a computing device such as a controller, a personal computer device, a mobile device, or another type of computing device. The endpoint device 108 can include a power meter, water meter, traffic controller, or another type of device that provides data to back-office management systems that monitor and/or control a number of endpoint devices 108. The endpoint device 108 includes, without limitation, a multi-carrier SIM 312, one or more processors 302, one or more network interfaces 306, one or more memories 308, and one or more power sources 310. The multi-carrier SIM 312 includes, without limitation, two or more profiles 314. The one or more memories 308 include, without limitation, a sector management agent 316 and report data 318.

The one or more processors 302 coordinate operations of the computing system 102. In various embodiments, processor 302 includes any hardware configured to process data and execute software applications. The processor 302 can be any technically feasible processing device configured to process data and execute program instructions. For example, processor 302 could include one or more CPUs, DSPs, GPUs, ASICs, FPGAs, microprocessors, microcontrollers, other types of processing units, and/or a combination of different processing units.

The one or more network interfaces 306 include devices configured to receive input, devices configured to provide output, and devices configured to both receive input and provide output. The one or more network interfaces 306 are configured to receive data and/or transmit data to and from devices providing the carrier networks 104 (see FIG. 1) and/or other service providers.

Memory 308 can include any technically feasible storage device, such as a random-access memory (RAM) module, a flash memory unit, a hard disk drive, non-volatile storage, or any other type of memory unit or combination thereof. In this example, memory 308 stores the sector management agent 316.

A power source 310 includes any source of power capable of energizing the endpoint device 108. In some examples, a power source 310 couples the endpoint device 108 to power from an electrical power grid such as an electrical outlet. In some examples, a power source 310 includes one or more energy storage devices such as batteries, fuel cells, and so on. In some examples, a power source 310 includes energy harvesting components such as solar harvesting components, vibration and other motion energy harvesting components, and so on.

The multi-carrier SIM 312 includes any SIM that enables communication with multiple carrier networks 104 and network sectors 106. The multi-carrier SIM 312 can refer to a removable SIM or a device integrated SIM such as an eSIM or an iSIM. Various examples of the multi-carrier SIM 312 include an integrated circuit located on a removable SIM card, an integrated circuit component that is permanently installed to the endpoint device 108, or a software SIM stored by a component of the endpoint device 108. The multi-carrier SIM 312 includes two or more profiles 314. A profile 314 configures the multi-carrier SIM 312 (and the endpoint device 108) to utilize a specified network sector 106 and/or carrier network 104.

The endpoint device 108 in the shown example also includes a sector management agent 316. The sector management agent 316 is configured to transmit commands for the multi-carrier SIM 312 to switch between the various profiles 314 in response to instructions received from the connectivity management service 110. Changing the profile 314 causes the endpoint device 108 to change network sectors 106 and/or carrier networks 104. In some cases, the profile 314 is a carrier profile, and changing a carrier profile to a new or updated carrier network 104 causes the endpoint device 108 to change to a different network sector 106 (e.g., the network sector 106 of the updated carrier network 104 corresponding to the location of the endpoint device 108). However, in other examples, the profile 314 configures the endpoint device 108 to use a specified carrier network 104 corresponding to a carrier network 104, such that the endpoint device 108 uses the specified network sector 106 even if other network sectors 106 of the carrier network 104 are available and in range of the endpoint device 108.

The report data 318 includes the connectivity data 234. The report data 318 also includes system information about the endpoint device 108, CPU usage, memory utilization, software installed and/or executing, device uptime, device (e.g., software and firmware) error rates, transaction volumes, system alerts, device hardware, and so on. The report data 318 includes physical information of the endpoint device 108 such as a device location 236, temperature, humidity, air pressure, elevation, and so on. The report data 318 includes enterprise-specific analytics, for example, based on sensor values and other data available to the endpoint device 108.

In operation, the endpoint device 108 receives instructions and commands from the connectivity management service 110 and implements actions according to the instructions. The endpoint device 108 receives, from the connectivity management service 110, instructions to provide report data 318. The endpoint device 108 responds by transmitting the report data 318 to the connectivity management service 110 according to the instructions. The endpoint device 108 also receives, from the connectivity management service 110, instructions to change a network sector 106 and/or carrier network 104. The endpoint device 108 (e.g., sector management agent 316) responds by switching between the various profiles 314 in response to instructions received from the connectivity management service 110. The endpoint device 108 receives and implements other instructions, such as instructions to record and/or compile specified information as report data 318, and/or the like.

### Changing Network Sectors

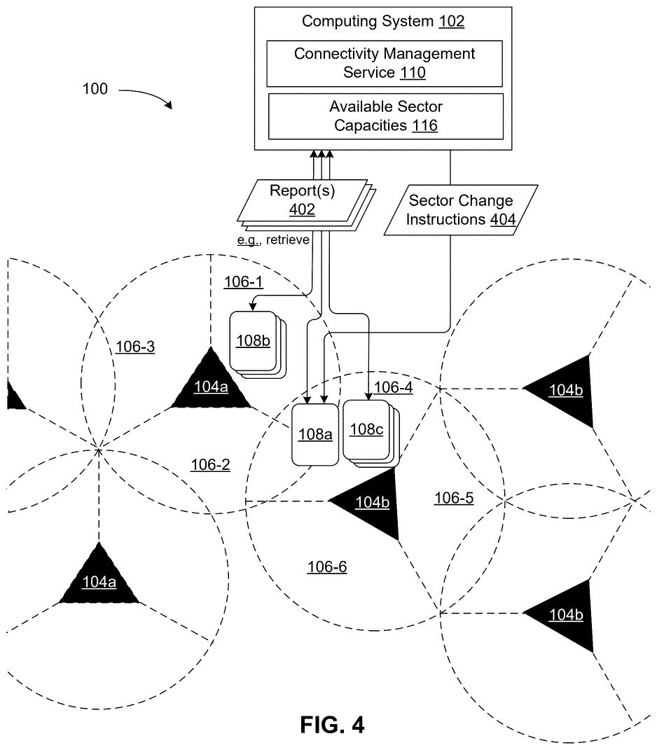

FIG. 4 illustrates an example of operations performed by the connectivity management service 110 in the networked environment 100 of FIG. 1, according to various embodiments. As shown, the networked environment 100 includes, without limitation, a computing system 102, carrier networks 104a and 104b, network sectors 106-1, 106-2, 106-3, 106-4, 106-5, and 106-6 (among other unlabeled network sectors 106), a endpoint device 108a, one or more endpoint devices 108b, and one or more endpoint devices 108c. The computing system 102 includes, without limitation, a connectivity management service 110 and available sector capacities 116. The connectivity management service 110 communicates data that includes, without limitation, reports 402 received from the various endpoint devices 108, and sector change instructions 404 transmitted to the endpoint device 108a.

The carrier network 104a provides a cellular or other type of wide area network that includes network sectors 106-1, 106-2, and 106-3, among other network sectors 106 that are unlabeled in the figure. The carrier network 104a includes one or more base stations (and other hardware) indicated by the triangles labeled “104a.” In this example, each base station of the carrier network 104a provides three network sectors 106 for the sake of readability and convenience. However, base stations of the carrier network 104a can provide any one or more network sectors 106 arranged in any orientation.

The carrier network 104b provides a cellular or other type of wide area network that includes network sectors 106-4, 106-6, and 106-6, among other network sectors 106 that are unlabeled in the figure. The carrier network 104b includes one or more base stations (and other hardware) indicated by the triangles labeled “104b.” In this example, each base station of the carrier network 104b provides three network sectors 106 for the sake of readability and convenience. However, base stations of the carrier network 104b can provide less than three (e.g., one or two) or more than three (e.g., four, five, ten or more) network sectors 106 arranged in any orientation, including network sectors 106 that can partially or fully overlap.

In the example shown, the coverage areas of network sectors 106-1 and 106-2 of carrier network 104a overlap with a coverage area of 106-4 of carrier network 104b. While the other coverage areas corresponding to the network sectors 106 of carrier network 104a and carrier network 104b are mostly separate for clarity, it is understood that the carrier network 104a and the carrier network 104b can provide coverage areas using network sectors 106 that have significant overlap. In the example shown, some of the network sectors 106 of carrier network 104a overlap with one another. Other are shown as distinct for clarity of the figure. While the network sector 106-1 of carrier network 104a is shown as distinct from the network sectors 106-2 and 106-3, the border between the coverage areas can overlap in practice.

In order to determine an available sector capacity 116 for network sector 106-1, the connectivity management service 110 receives reports 402 from the endpoint devices 108 of the network sector 106-1. In this example, the endpoint device 108a and one or more endpoint devices 108b are connected using the network sector 106-1. The reports 402 are received and/or retrieved with at least partial concurrence in order to put a level of load on the network sector 106-1 that enables the connectivity management service 110 to identify the available sector capacity 116. In some embodiments, the connectivity management service 110 transmits instructions (not shown) for endpoint devices 108 in the network sector 106-1 to provide reports 402.

The connectivity management service 110 receives the reports 402 from the endpoint devices 108a and 108b. A sector latency 112 is measured based on an aggregate, average, time it takes the connectivity management service 110 to receive the reports 402. A starting time is a configured starting time for the one or more endpoint devices 108 in the network sector 106-1 to provide the reports 402. The ending time for one or more endpoint devices 108, is a time that the connectivity management service 110 to receives the one or more reports 402. The connectivity management service 110 identifies the sector latency 112 and sector connection data 230 based on the reporting process. The sector connection data 230 can include a failure rate for the reporting process, aggregated report data 318 from the endpoint devices 108, as well as connectivity data 234 such as disconnection rates, signal strengths, and so on.

The connectivity management service 110 identifies sector latencies 112 for multiple network sectors 106. The connectivity management service 110 determines the available sector capacities 116 based on the sector latencies 112 and estimated sector capacities 114 for each network sector 106. In this example, the connectivity management service 110 determines that the network sector 106-1 has a lower available sector capacity 116 than the network sector 106-4 and the network sector 106-2. As a result, the connectivity management service 110 determines to reassign at least one or more of the endpoint devices 108 of the network sector 106-1.

The connectivity management service 110 identifies that the endpoint device 108a has a lower signal strength and/or a higher disconnection rate as compared to the endpoint devices 108b. As a result, the connectivity management service 110 determines to reassign the endpoint device 108a from the network sector 106-1 to one of the network sectors 106-4 or 106-2. The connectivity management service 110 identifies that endpoint device 108a has a lower signal strength and/or higher disconnection rate in network sector 106-2, relative to the network sector 106-1 and/or the network sector 106-4. The connectivity management service 110 identifies that endpoint device 108a has a higher signal strength and/or lower disconnection rate in network sector 106-4, relative to the network sector 106-1 and/or the network sector 106-2. Low signal strength and high disconnection rates can cause an endpoint device 108 to use an inordinate amount of network bandwidth and power usage.

The connectivity management service 110 maximizes the network bandwidth and power usage in the overall system by reassigning the endpoint device 108a to the network sector 106-4. The connectivity management service 110 transmits sector change instructions 404 that cause the endpoint device 108a to connect to the network sector 106-4. The sector change instructions 404 can include instructions to change profiles to a specified profile 314. The endpoint device 108a receives the sector change instructions 404 and changes a current profile 314 to an updated profile 314 that specifies the network sector 106-4 and/or the carrier network 104b.

### Load Balancing Decisions

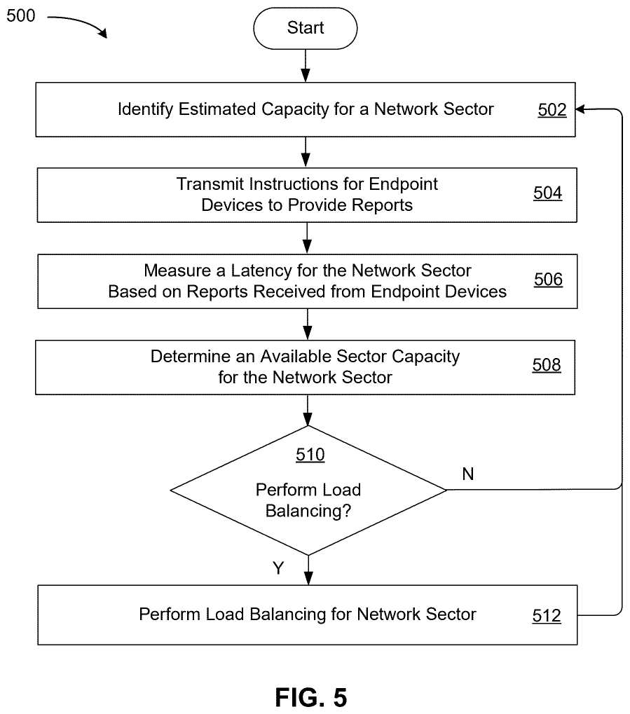

FIG. 5 illustrates a flow diagram of method steps for the connectivity management service 110 to determine whether to perform load balancing, according to various embodiments. Although the method steps are shown in an order, persons skilled in the art will understand that some method steps may be performed in a different order, repeated, omitted, and/or performed by components other than those described in FIG. 5. Although the method steps are described with respect to the systems of FIGS. 1-4, persons skilled in the art will understand that any system configured to perform the method steps, in any order, falls within the scope of the various embodiments.

As shown, a method 500 begins at step 502, where the connectivity management service 110 identifies an estimated sector capacity 114 for a network sector 106. The estimated sector capacity 114 is a sector-specific practical upper limit capacity, or another measure. The connectivity management service 110 determines estimated sector capacity 114 based on an allocated capacity such as a service level capacity according to a contract with a carrier network 104 that provides the network sector 106. The connectivity management service 110 also considers one or more protocols used by the network sector 106, which can affect the capacity provided by a network sector 106 in practice.

At step 504, the connectivity management service 110 transmits instructions for endpoint devices 108 of the network sector 106 to provide reports 402. The connectivity management service 110 identifies a set of endpoint devices 108 that connect using the network sector 106. For example, the connectivity management service 110 uses a sector identifier 222 to retrieve the corresponding device identifiers 224 in the sector data 212. The connectivity management service 110 identifies communication information for the corresponding endpoint devices 108 and transmits instructions such as commands or requests to provide reports 402. In some embodiments, the reports 402 are received and/or retrieved with at least partial concurrence in order to create at least a minimum level of load on the network sector 106.

At step 506, the connectivity management service 110 measures sector latency 112 of the network sector 106. The connectivity management service 110 measures sector latency 112 based on an aggregate, average, time it takes the connectivity management service 110 to receive the reports 402 from a time the endpoint devices 108 are instructed to provide the reports 402. The connectivity management service 110 identifies the sector latency 112 and sector connection data 230 based on the reporting process. The sector connection data 230 can include a failure rate for the reporting process, aggregated report data 318 from the endpoint devices 108, and connectivity data 234 such as disconnection rates, signal strengths, and other.

At step 508, the connectivity management service 110 determines an actual available capacity 116 for the network sector 106. The connectivity management service 110 determines an available sector capacity 116 using the estimated sector capacity 114, the sector latency 112, and sector connection data 230 such as disconnection rates and signal strengths. The connectivity management service 110 identifies a relationship or set of rules that inversely relates sector latency 112 with available sector capacity 116. In some embodiments, the relationship or set of rules further directly relates disconnection rates with available sector capacity 116. In some embodiments, the relationship or set of rules directly relates disconnection rates signal strengths with available sector capacity 116.

At step 510, the connectivity management service 110 determines whether to perform load balancing operations or actions with respect to the network sector 106. For example, the connectivity management service 110 compares the available sector capacity 116 for the network sector 106 to a threshold sector capacity for the network sector 106, and/or other available sector capacities 116 for other network sectors 106. If the available sector capacity 116 for the network sector 106 crosses a threshold sector capacity or exceeds the other available sector capacities 116 for other network sectors 106, the connectivity management service 110 moves to step 512. Otherwise, the connectivity management service 110 moves to step 502 and performs steps 502-510 for another network sector 106.

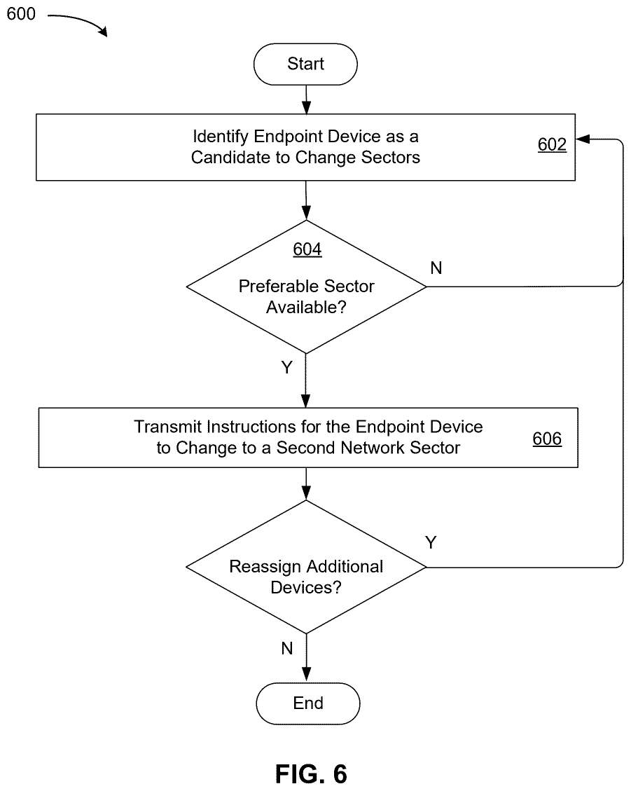

In step 512, the connectivity management service 110 performs load balancing for the network sector 106. In some examples, the connectivity management service 110 identifies a target sector capacity for the network sector 106, based on the available sector capacity 116 for the network sector 106 and the available sector capacities 116 for other network sectors 106. The connectivity management service 110 reassigns one or more endpoint devices 108 to achieve the target sector capacity. In some embodiments, the target sector capacity is within a configured difference (e.g., value and/or percentage) from an average or mean available sector capacity 116 for the network sectors 106. The connectivity management service 110 selects specific endpoint devices 108 to reassign (e.g., to change network sectors 106) as described with respect to FIG. 6.

FIG. 6 illustrates a flow diagram of method steps for the connectivity management service 110 to perform load balancing of a network sector 106, according to various embodiments. Although the method steps are shown in an order, persons skilled in the art will understand that some method steps may be performed in a different order, repeated, omitted, and/or performed by components other than those described in FIG. 6. Although the method steps are described with respect to the systems of FIGS. 1-4, persons skilled in the art will understand that any system configured to perform the method steps, in any order, falls within the scope of the various embodiments.

As shown, a method 600 begins at step 602, where the connectivity management service 110 identifies an endpoint device 108 as a candidate to change network sectors 106. The endpoint devices 108 that have a lower signal strength and/or a higher disconnection rate relative to other endpoint devices 108 in the current network sector 106 use an inordinate amount of power and bandwidth. In some embodiments, the connectivity management service 110 ranks or otherwise evaluates the endpoint devices 108 of the network sector 106 based on signal strength and/or disconnection rate. Accordingly, the connectivity management service 110 identifies an endpoint device 108 as a candidate to change network sectors 106 based on the signal strength and/or disconnection rate of the endpoint device 108 relative to other endpoint devices 108 in the network sectors 106.

At step 604, the connectivity management service 110 determines whether the candidate endpoint device 108 has a higher signal strength and/or lower disconnection rate in another network sector 106. The connectivity management service 110 accesses historical connectivity data 234 of the endpoint device 108 to determine whether the candidate endpoint device 108 has a higher signal strength and/or lower disconnection rate in any other network sector 106 that provides coverage area in the location of the candidate endpoint device 108. The connectivity management service 110 also filters the network sectors 106 to those that have greater available sector capacity 116 than the current network sector 106 of the candidate endpoint device 108. the candidate endpoint device 108 has a higher signal strength and/or lower disconnection rate in another network sector 106, the connectivity management service 110 selects the candidate endpoint device 108 for reassignment and moves to step 606. Otherwise, the connectivity management service 110 moves to step 602 and identifies another endpoint device 108 to assess for sector reassignment.

At step 606, the connectivity management service 110 transmits sector change instructions 404 to the endpoint device 108 (e.g., the selected endpoint device 108). The sector change instructions 404 instruct the endpoint device 108 to change sectors to the network sector 106 where the candidate endpoint device 108 has a higher signal strength and/or lower disconnection rate.

At step 608, the connectivity management service 110 determines whether to reassign additional endpoint devices 108. In some embodiments, the connectivity management service 110 reassigns one or more endpoint devices 108 to achieve a target sector capacity such as a configured difference (e.g., value and/or percentage) from an average or mean of the available sector capacity 116 for a set of network sectors 106. The connectivity management service 110 calculates a post-sector-change available sector capacity 116 for the previous network sector 106 and determines if the target sector capacity is reached. If the target sector capacity is reached, the connectivity management service 110 the process ends. Otherwise, the connectivity management service 110 moves to step 602 and identifies an additional endpoint device 108 to assess for sector reassignment.

### Endpoint Device Sector Switching

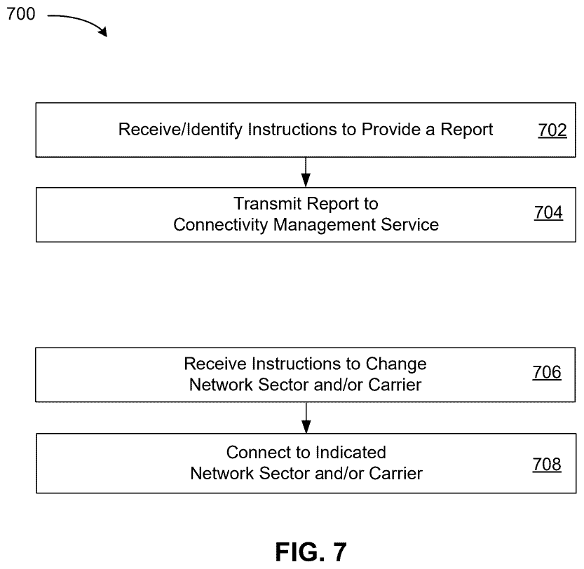

FIG. 7 illustrates a flow diagram of method steps for an endpoint device to facilitate one or more load balancing operations, according to various embodiments. Although the method steps are shown in an order, persons skilled in the art will understand that some method steps may be performed in a different order, repeated, omitted, and/or performed by components other than those described in FIG. 7. Although the method steps are described with respect to the systems of FIGS. 1-4, persons skilled in the art will understand that any system configured to perform the method steps, in any order, falls within the scope of the various embodiments.

As shown, a method 700 begins at step 702, where the endpoint device 108 identifies or receives and/or identifies instructions to provide a report 402. In some embodiments, the connectivity management service 110 transmits instructions to provide a report 402. Additionally or alternatively, the endpoint device 108 stores instructions to provide a report 402 periodically or on another configurable scheduled basis. In some cases, the connectivity management service 110 transmits instructions to provide a report 402 periodically or on another configurable scheduled basis, and the endpoint device 108 stores the instructions for reference. The endpoint device 108 is also configured to identify data for the report 402. In some embodiments, the data for the report 402 includes connectivity data 234. Connectivity data 234 includes a history of signal strengths, disconnections, and other connectivity information that is identified and stored by an endpoint device 108 periodically. In some embodiments, the data for the report 402 includes report data 318.

The report data 318 includes connectivity data 234 indicating a history of signal strengths, disconnections, and other connectivity information that is identified and stored by an endpoint device 108 over time (e.g., since a previous report 402). The report data 318 also includes system information about the endpoint device 108, CPU usage, memory utilization, software installed and/or executing, device uptime, device (e.g., software and firmware) error rates, transaction volumes, system alerts, device hardware, and so on. The report data 318 includes physical information of the endpoint device 108 such as a device location 236, temperature, humidity, air pressure, elevation, and so on. The report data 318 includes enterprise-specific analytics, for example, based on sensor values and other data available to the endpoint device 108.

At step 704, the endpoint device 108 transmits the report 402 to the connectivity management service 110. The endpoint device 108 stores communication information that includes a communication interface of the connectivity management service 110, authentication information, and so on. The communication interface includes an application programming interface or another programmatic interface through which the connectivity management service 110 receives and processes reports 402. The connectivity management service 110 receives the report 402, as well as reports 402 from other endpoint devices 108. The connectivity management service 110 identifies whether to perform load balancing operations or actions with respect to various network sectors 106.

In this example, the connectivity management service 110 determines to perform load balancing for the network sector 106 of the endpoint device 108, for example, as discussed with respect to FIG. 5. The connectivity management service 110 determines that the endpoint device 108 is to be reassigned to a different network sector 106, for example, as discussed with respect to FIG. 6. As a result, connectivity management service 110 transmits instructions for the endpoint device 108 to change network sectors 106.

At step 706, the endpoint device 108 receives the sector change instructions 404 indicating for the endpoint device 108 to change network sectors 106 and/or carrier networks 104. The sector change instructions 404 specify a profile 314 corresponding to an updated network sector 106 and/or carrier network 104 for the endpoint device 108.

At step 708, the endpoint device 108 changes a current profile 314 to an updated profile 314 that specifies the network sector 106 and/or the carrier network 104. For example, the endpoint device 108 commands the multi-carrier SIM 312 to switch profiles 314 to the updated profile 314. The endpoint device 108 connects to a network and communicates using the updated network sector 106.

In sum, techniques are disclosed herein for providing a connectivity management service that selects network sectors for endpoint devices. According to various embodiments, a connectivity management service that identifies an estimated capacity for a first network sector corresponding to a first carrier network, measures average latency for the network sector based on endpoint devices that communicate using the network sector, determines an actual available capacity for the network sector based on the average latency and the estimated capacity, and transmits instructions for an endpoint device of the endpoint devices to change from the first network sector to a second network sector.

At least one technical advantage of the disclosed techniques is that the disclosed techniques increase overall actual capacity across all sectors utilized by an enterprise. The disclosed techniques reduce disconnection rates and power usage while available capacity is balanced across all sectors. Additionally, the disclosed techniques further increase overall actual capacity across all sectors and increases battery lifetime for battery-powered endpoint devices. These technical advantages represent one or more technological improvements over prior art approaches.

The following clauses describe aspects of various embodiments.

1. In some embodiments, a method comprises identifying, by a connectivity management service, an estimated capacity for a first network sector of a plurality of network sectors, wherein the first network sector corresponds to a first carrier network of a plurality of carrier networks, measuring, by the connectivity management service, an average latency for the first network sector based on a plurality of endpoint devices that communicate using the first network sector, determining, by the connectivity management service, an actual available capacity for the first network sector based on the average latency and the estimated capacity, and transmitting, by the connectivity management service, instructions for an endpoint device of the plurality of endpoint devices to change from the first network sector to a second network sector.

2. The method of clause 1, wherein the second network sector corresponds to a second network carrier.

3. The method of clauses 1 or 2, further comprising transmitting, by the connectivity management service, instructions for the plurality of endpoint devices to provide report data that includes connectivity information, and receiving, by the connectivity management service, the report data from the plurality of endpoint devices, wherein the average latency for the first network sector is measured based on one or more durations of time from transmitting the instructions to receiving the report data.

4. The method of any of clauses 1-3, wherein the endpoint device is selected based on the connectivity information in the report data.

5. The method of any of clauses 1-4, further comprising calculating, by the connectivity management service, the estimated capacity based on at least one of a protocol used by the first network sector, or an allocated bandwidth of the first network sector.

6. The method of any of clauses 1-5, wherein the second network sector is associated with a higher actual available capacity relative to the actual available capacity of the first network sector.

7. The method of any of clauses 1-6, further comprising selecting, by the connectivity management service, the endpoint device to change network sectors based on one or more of a lower signal strength or a higher disconnection rate relative to other ones of the plurality of endpoint devices of the first network sector.

8. The method of any of clauses 1-7, further comprising identifying, by the connectivity management service, historical connectivity data indicating that the endpoint device is associated with a higher signal strength for the second network sector relative to the first network sector.

9. The method of any of clauses 1-8, further comprising comparing, by the connectivity management service, a plurality of available capacities for the plurality of network sectors to identify the first network sector for one or more load balancing actions, wherein the one or more load balancing actions include transmitting, by the connectivity management service, the instructions for the endpoint device to change from the first network sector to the second network sector.

10. In some embodiments, one or more non-transitory computer-readable media store instructions which, when executed by one or more processors, cause the one or more processors to perform operations comprising estimating, by a connectivity management service, a capacity of a first network sector of a plurality of network sectors, determining, by the connectivity management service, a sector-specific reporting latency based on a plurality of endpoint devices that communicate using the first network sector, evaluating, by the connectivity management service, an actual available capacity for the first network sector based on the sector-specific reporting latency and the capacity estimated for the first network sector, and sending, by the connectivity management service, instructions for an endpoint device of the plurality of endpoint devices to change from the first network sector to a second network sector.

11. The one or more non-transitory computer-readable media of clause 10, wherein the estimated capacity is estimated based on at least one of a protocol used by the first network sector, or an allocated bandwidth of the first network sector.

12. The one or more non-transitory computer-readable media of clauses 10 or 11, wherein the operations further comprise receiving, by the connectivity management service, reports from the plurality of endpoint devices, wherein the sector-specific reporting latency is based on one or more durations of time for receiving the reports.

13. The one or more non-transitory computer-readable media of any of clauses 10-12, wherein the operations further comprise selecting, by the connectivity management service, the endpoint device to change network sectors based on a comparison of connectivity information for the endpoint device relative to one or more of the first network sector and the second network sector.

14. The one or more non-transitory computer-readable media of any of clauses 10-13, selecting, by the connectivity management service, the second network sector based on historical data indicating that the endpoint device is associated with a higher signal strength for the second network sector relative to the first network sector.

15. The one or more non-transitory computer-readable media of any of clauses 10-14, wherein the operations further comprise identifying, by the connectivity management service, a geographic location of the endpoint device, wherein the second network sector is a network sector of a first carrier network or a second carrier network corresponding to the geographic location.

16. The one or more non-transitory computer-readable media of any of clauses 10-15, wherein the operations further comprise predicting, by the connectivity management service, a post-sector change available capacity for at least one of the first network sector or the second network sector.

17. In some embodiments, a computing system comprises one or more processors, and a memory storing executable instructions that, when executed by the one or more processors, cause the one or more processors to perform operations comprising identifying, by a connectivity management service, an estimated capacity for a first network sector of a plurality of network sectors, measuring, by the connectivity management service, a sector-specific latency metric for the first network sector based on a plurality of endpoint devices that communicate using the first network sector, determining, by the connectivity management service, an available capacity for the first network sector based on the sector-specific latency metric and the estimated capacity, and transmitting, by the connectivity management service, instructions for an endpoint device of the plurality of endpoint devices to change network sectors to a second network sector.

18. The computing system of clause 17, wherein the operations further comprise selecting, by the connectivity management service, the endpoint device to change network sectors based on one or more of a signal strength of the endpoint device relative to the first network sector or a disconnection metric for the endpoint device relative to the first network sector.

19. The computing system of clauses 17 or 18, wherein the operations further comprise selecting, by the connectivity management service, the second network sector based on connectivity data of the endpoint device relative to one or more of the first network sector or the second network sector.

20. The computing system of any of clauses 17-19, wherein the instructions for the endpoint device to change sectors to the second network sector specify a carrier profile corresponding to the second network sector.

Any and all combinations of any of the claim elements recited in any of the claims and/or any elements described in this application, in any fashion, fall within the contemplated scope of the present protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments can be embodied as a system, method or computer program product. Accordingly, aspects of the present disclosure can take the form of an entirely hardware embodiment, an entirely software embodiment (including firmware, resident software, micro-code, etc.) or an embodiment combining software and hardware aspects that can all generally be referred to herein as a “module,” a “system,” or a “computer.” In addition, any hardware and/or software technique, process, function, component, engine, module, or system described in the present disclosure can be implemented as a circuit or set of circuits. Furthermore, aspects of the present disclosure can take the form of a computer program product embodied in one or more computer readable media having computer readable program code embodied thereon.

Any combination of one or more computer readable media can be utilized. The computer readable medium can be a computer readable signal medium or a computer readable storage medium. A computer readable storage medium can be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium can be any tangible medium that can contain or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions can be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors can be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams can represent a module, segment, or portion of code, which comprises one or more executable instructions for implementing the specified logical function(s). It should also be noted that, in some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure can be devised without departing from the basic scope thereof, and the scope thereof is determined by the claims that follow. Moreover, in the above description, numerous specific details are set forth to provide a more thorough understanding of the various embodiments. However, it will be apparent to one skilled in the art that the inventive concepts may be practiced without one or more of these specific details.

What is claimed is:

1. A method comprising:
identifying, by a connectivity management service, an estimated capacity for a first network sector of a plurality of network sectors, wherein the first network sector corresponds to a first carrier network of a plurality of carrier networks;
measuring, by the connectivity management service, an average latency for the first network sector based on a plurality of endpoint devices that communicate using the first network sector;
determining, by the connectivity management service, an actual available capacity for the first network sector based on the average latency and the estimated capacity; and
transmitting, by the connectivity management service, instructions for an endpoint device of the plurality of endpoint devices to change from the first network sector to a second network sector.

2. The method of claim 1, wherein the second network sector corresponds to a second network carrier.

3. The method of claim 1, further comprising:
transmitting, by the connectivity management service, instructions for the plurality of endpoint devices to provide report data that includes connectivity information; and
receiving, by the connectivity management service, the report data from the plurality of endpoint devices, wherein the average latency for the first network sector is measured based on one or more durations of time from transmitting the instructions to receiving the report data.

4. The method of claim 3, wherein the endpoint device is selected based on the connectivity information in the report data.

5. The method of claim 1, further comprising:
calculating, by the connectivity management service, the estimated capacity based on at least one of: a protocol used by the first network sector, or an allocated bandwidth of the first network sector.

6. The method of claim 1, wherein the second network sector is associated with a higher actual available capacity relative to the actual available capacity of the first network sector.

7. The method of claim 1, further comprising:
selecting, by the connectivity management service, the endpoint device to change network sectors based on one or more of a lower signal strength or a higher disconnection rate relative to other ones of the plurality of endpoint devices of the first network sector.

8. The method of claim 1, further comprising:
identifying, by the connectivity management service, historical connectivity data indicating that the endpoint device is associated with a higher signal strength for the second network sector relative to the first network sector.

9. The method of claim 1, further comprising:
comparing, by the connectivity management service, a plurality of available capacities for the plurality of network sectors to identify the first network sector for one or more load balancing actions, wherein the one or more load balancing actions include transmitting, by the connectivity management service, the instructions for the endpoint device to change from the first network sector to the second network sector.

10. One or more non-transitory computer-readable media storing instructions which, when executed by one or more processors, cause the one or more processors to perform operations comprising:
estimating, by a connectivity management service, a capacity of a first network sector of a plurality of network sectors;
determining, by the connectivity management service, a sector-specific reporting latency based on a plurality of endpoint devices that communicate using the first network sector;
evaluating, by the connectivity management service, an actual available capacity for the first network sector based on the sector-specific reporting latency and the capacity estimated for the first network sector; and
sending, by the connectivity management service, instructions for an endpoint device of the plurality of endpoint devices to change from the first network sector to a second network sector.

11. The one or more non-transitory computer-readable media of claim 10, wherein the estimated capacity is estimated based on at least one of: a protocol used by the first network sector, or an allocated bandwidth of the first network sector.

12. The one or more non-transitory computer-readable media of claim 10, wherein the operations further comprise:
receiving, by the connectivity management service, reports from the plurality of endpoint devices, wherein the sector-specific reporting latency is based on one or more durations of time for receiving the reports.

13. The one or more non-transitory computer-readable media of claim 10, wherein the operations further comprise:
selecting, by the connectivity management service, the endpoint device to change network sectors based on a comparison of connectivity information for the endpoint device relative to one or more of the first network sector and the second network sector.

14. The one or more non-transitory computer-readable media of claim 10, selecting, by the connectivity management service, the second network sector based on historical data indicating that the endpoint device is associated with a higher signal strength for the second network sector relative to the first network sector.

15. The one or more non-transitory computer-readable media of claim 10, wherein the operations further comprise:
identifying, by the connectivity management service, a geographic location of the endpoint device, wherein the second network sector is a network sector of a first carrier network or a second carrier network corresponding to the geographic location.

16. The one or more non-transitory computer-readable media of claim 10, wherein the operations further comprise:
predicting, by the connectivity management service, a post-sector change available capacity for at least one of the first network sector or the second network sector.

17. A computing system, comprising:
one or more processors; and
a memory storing executable instructions that, when executed by the one or more processors, cause the one or more processors to perform operations comprising:
identifying, by a connectivity management service, an estimated capacity for a first network sector of a plurality of network sectors;
measuring, by the connectivity management service, a sector-specific latency metric for the first network sector based on a plurality of endpoint devices that communicate using the first network sector;
determining, by the connectivity management service, an available capacity for the first network sector based on the sector-specific latency metric and the estimated capacity; and
transmitting, by the connectivity management service, instructions for an endpoint device of the plurality of endpoint devices to change network sectors to a second network sector.

18. The computing system of claim 17, wherein the operations further comprise:
selecting, by the connectivity management service, the endpoint device to change network sectors based on one or more of a signal strength of the endpoint device relative to the first network sector or a disconnection metric for the endpoint device relative to the first network sector.

19. The computing system of claim 17, wherein the operations further comprise:
selecting, by the connectivity management service, the second network sector based on connectivity data of the endpoint device relative to one or more of the first network sector or the second network sector.

20. The computing system of claim 17, wherein the instructions for the endpoint device to change sectors to the second network sector specify a carrier profile corresponding to the second network sector.
